(19) United States
(12) Patent Application Publication
(10) Pub. No.: US 2004/0090793 A1
(43) Pub. Date: May 13, 2004

(54) Light rod for use in an illumination device, and a method of manufacturing and fastening the rod

(76) Inventor: Goran Morsing, Stockholm (SE)

Correspondence Address: DICKSTEIN SHAPIRO MORIN & OSHINSKY LLP, 2101 L STREET NW, WASHINGTON, DC, 20037-1526, US

(21) Appl. No.: 10/469,404

(22) PCT Filed: Feb. 28, 2002
(86) PCT No.: PCT/SE02/00358

(30) Foreign Application Priority Data
Mar. 1, 2001 (SE) 0100705-3

(51) Int. Cl. F21V 7/04

(52) U.S. Cl. 362/551; 362/555; 362/800; 362/31; 362/30; 362/558

(57) ABSTRACT

The present invention relates to a lens or light rod for creating of a transparent coloured or un-coloured light transmission, in the first hand preferably in an object in the form of a body of a plastic boat, car body, aircraft body or the like or objects in the form of tanks, swimming pools or the like, whereby a light communication can be maintained through the same or from an embedded light source and outwards. The light rod (1) comprises a body (2) a plastic material chemically or mechanically compatible to the actual fastening position, said body has an extendion which after the fastening makes a fixing in position of the body (2) possible to the inside (4) of the object (3) and also an accommodation of that portion of the body which protrudes in a direction outside the object (3) by working of the same into theouter contour (5) of the object (3), alternatively vice versa during mounting of the light rod in an object in the form of tanks, swimming pools or the like where the protruding portion of the light rod is accommodated to the inner edges and inner form of the object by working.

The present invention refers to an improvement in and relating to a lens or light rod in creating of a transparent, coloured or uncoloured light transmission in the first hand preferably in an object in the form of a body of a plastic boat, car body, aircraft body or the like or an object in form of tanks, swimming pools or the like, whereby a light communication can be maintained through the same or from an embedded light source or out from the same. Alternatively the light rod in the second hand can be used for creating a transparent coloured or uncoloured light transmission in an object in the form of preferably bodies, car bodies, containers, tanks or the like, where the object in question is manufactured by wood, metal, concrete or other material which doesn't consist of reinforced plastic and in this case a light transmission via a collar or a flange supporting said light rod, said collar or flange is integrated into the casing or mantle surface of the light rod and which collar can support said light rod against the object by aid of bolts or screw joints.

One object according to the present invention is to provide a light rod of the kind mentioned above, which is integratable to the object, in which the light rod is mounted either afterwards in an already existing object or in connection with the manufacturing of that object. By integrating of the light rod to the object in question a formation adapted to the contour of the object is achieved by the outer portion of the light rod. Examples of applications of use for the light rod according to the present invention are several and those which can be mentioned are for example one for mounting of a light rod below the water line on a boat body, which is manufactured of glass fiber reinforced polyester, and one another light rod which is used as underwater headlights. In the same way the light rod can be used as a light of swimming pools, aquariums, etc., which are manufactured of glass fiber reinforced polyester. The light rod can also be used e.g. as a distance meter, which works with IR or laser light. The characterizing features of the invention are set forth in the claims enclosed.

Thanks to the invention a lens or a light rod of the kind mentioned above is provided which in an excellent way fulfills its purposes at the same time as it is also cheap and easy to manufacture. In connection with or after the montage of the light rod one can obtain an accommodation of the front portion of the light rod in accordance with the outer or inner form of the object by a suitable working.

The invention will be described closer below by aid of some preferred embodiment examples with reference to the drawings enclosed, in which

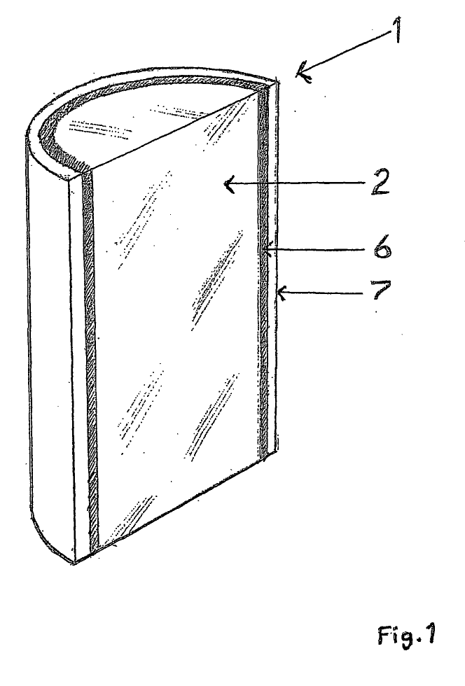

FIG. 1 shows a schematic perspective cross section view through a cylinder formed light rod according to the invention,

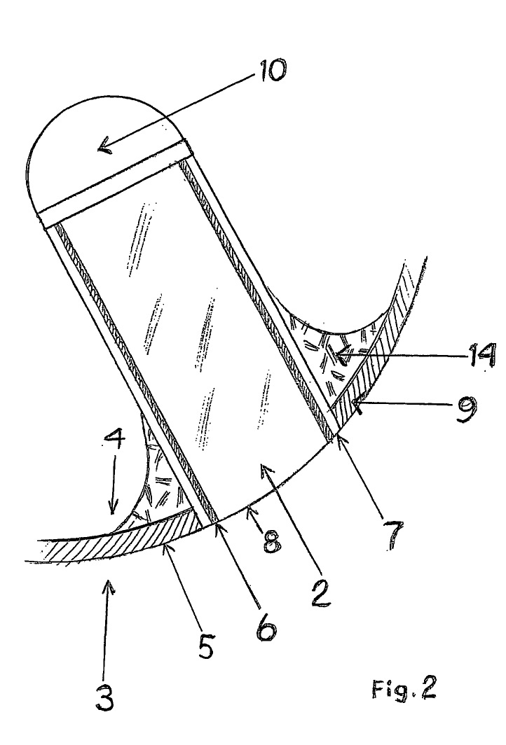

FIG. 2 shows a schematic section view through a light rod according to the invention mounted below the water line on a boat body and which is used as a lens for an underwater headlamp and

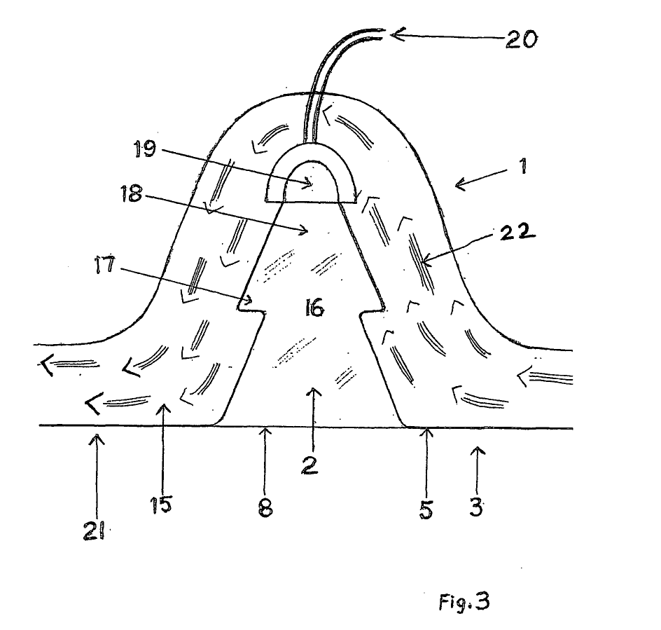

FIG. 3 shows a schematic cross section view of an integrated and pressure safe composite light rod according to the invention mounted through a submarine body and which is used as a lens for e.g. a distance meter which works with IR or laser light.

In FIG. 1 a lens or light rod 1 according to a preferred embodiment example is illustrated which is intended to create a transparent coloured or uncoloured light transmission in an object preferably in the form of a body to a plastic boat, car body, aircraft body or the like or objects in the form of tanks, swimming pools or the like and alternatively when the object is manufactured by wood, metal, concrete or other material which is not reinforced plastic, a collar or flange prefabricated and integrated on the same is used during the mounting of the light rod, said collar or flange thereafter by aid of bolts or screw joints is intended to support said light rod against the object in question, whereupon the light rod can be accommodated by working to opposite side contours of the object. Thus, by the light rod a light communication can be maintained or from a light source which is cast into the same having its beams directed outwards.

In the illustrated, preferred embodiment examples the lens or light rod 1 consists of a body 2 of a plastic material chemically or mechanically compatible to the actual fastening position, said body having an extension, which after mounting makes a fastening of the body 2 against the inside 4 of the object 3 possible and also an accommodation of the same of that part or portion, which protrudes in a direction outside said object 3 by working of the same to the outer contour 5 of the object 3. Alternatively an opposite way of manufacturing is used in positioning or mounting of the light rod in objects in the form of tanks, swimming pools, and the like, where the protruding portion by working is accommodated to the inner edges of the object and the inner formation of the object.

With the expression compatible plastic materials is meant that the light rod 1 is manufactured by plastic, which has the same or not disconnected, chemical mixture, as that plastic the object 3 in question consists of and in which object the light rod is intended to be fastened and penetrate. The form, appearance and size of the light rod can of course be varied as well as the plastic materials the light rod can be manufactured of.

As can be seen closer from FIG. 1 a cylindrical composite light rod 1 is illustrated, the body of which consists of a transparent plastic having eventual reinforcements embedded. Outside this there is an eventual reflection layer 6 and an eventual, covering, reinforced outer layer 7, the both layers 6, 7 being manufactured before or after the mounting of the body 2, where in said outer layer eventual fastening devices can be integrated. The body 2 which constitutes the light rod 1 has a cross section which is tube formed, square formed, oval-shaped or formed with edges and as can be seen from FIG. 1 this rod is formed like a tube and has a longitudinal section which is formed straight, conically or spherically. The plastic materials which can be used in the different layers are each compatible i.e. have the same mixture or not disconnecting chemical mixture and the light rod 1 as a whole is manufactured by a plastic material, which is compatible with the material in which the same shall be fastened as well as that plastic which is used during the fastening process.

The extension or length of the light rod 1 has such a dimension that the front part or portion 8, after i.e. mounting in a boat body 9, protrudes in such a length direction outwards outside the contour of the body 9, that the same can be accommodated with suitable working tools to the same outer form as the body form itself, independent of the positioning of the light rod 1 in the body 9.

As can be seen in more detail in FIG. 2 a cross section of a composite light rod 1 is illustrated which is manufactured of polyester and mounted below the water line of a body 9 of a boat, which is manufactured of glass fiber reinforced polyester and in which the light rod 1 is used for an underwater head lamp 10. In this case the transparent body 2 of the light rod 1 consists of a polyester plastic 11. The reflection surface 12 of the light rod 1 consists of white polyester gelcote and upon this there is a glass fiber reinforced polyester layer 13, which extends around the mantle or casing of the light rod 1. As a fitting 14 of said light rod 1 a glass fiber reinforced polyester is used. The same fastening method can also be used for a light by aid of the light rod 1 in swimming pools, aquariums, etc, which are manufactured for example by glass fiber reinforced polyester.

In FIG. 3 an embodiment example is illustrated where the light rod is integrated and pressure safe mounted in a submarine body 15, which in turn is manufactured by carbon fiber reinforced epoxy and in those cases the light rod 1 is used as a lens or a light transmission for e.g. a distance meter, which works with IR- or laser light. The light rod 1 in this case has a special, in its cross section, arrow-like form, where the front portion 8 is accommodated to a level in line with the outside 21 of the submarine body 15 and where its middle portion 16 has a flange 17 for a secure fixing to the submarine body 15. The back portion 11 of the light rod 1 is provided with a light transmitter 19, from which wiring 20 extends into the inner portion of a submarine to actual equipment. In this embodiment example it is suitable that the light rod is manufactured separately owing to eventual shrinking, so that it thereafter can be integrated into the laminate of the body 15. In the figure the fiber direction 22 of the plastic is illustrated with arrows.

One method to manufacture a lens or light rod according to the invention can be made as follows. The light rod 1 is prefabricated in all stages from only the transparent portion and this portion in this case has a colouring and/or cast in reinforcements. After this the transparent portion in actual cases is provided with a reflection layer and a covering layer with or without flange for mechanical mounting via a bolt- or screw joint and/or other fastening devices, intended for supporting the light rod 1 to a base or object or for supporting of equipment details on said light rod. A transparent portion of the light rod is casted or mounted mechanically in its surrounding cover. In using of casting transmitters the back portion of the light rod is covered by the enclosing layer. According to the invention all layers of plastics of the light rod are manufactured with the same chemical mixing or other compatible material with those plastic materials which are used for the manufacturing of the actual object.

In the actual cases the light rod 1 is provided with a flange where the material in the flange is manufactured of plastic of the same mixture as in said light rod.

One method for securing of the lens or light rod I according to the invention to an actual object in the form of a body of a plastic boat, car body, aircraft body or the like, or objects in the form of tanks, swimming pools or the like is done in the following way. One opening is made in the object, the light rod is inserted into the opening such a distance that some part of the same protrudes outside the outer contour/inner contour of the object, a plastic material compatible to the light rod and object is applied between the inside/outside of the object and that part of the light rod 1, which is inside/outside and protrudes inwards/outwards in the object for attaching and integrating of said light rod in the opening and the object, whereupon that part of the light rod 1, which is outside/inside the object by working its adapted or accumulated to the form of the outer contour/inner contour of the object.

An alternative method for attachment of a light rod according to the invention in preferably an object in the form of a boat body, car body, container, tank or the like, manufactured by wood, metal, concrete or other material, which does not consist of reinforced plastic is done in the following way. An opening is made in the object, whereupon the light rod 1 is inserted into the opening, to that it protrudes outwards, alternatively lies in a plane or level with the opposite side of the object and a collar or flange manufactured during the mounting process of the same and prefabricated on the mantle surface of the light rod, said collar or flange is integrated into the enclosing layer of the light rod, by aid of bolts or screw joint attaches the light rod to the object in question, whereupon the light rod by working is accommodated to the opposite side contours of the object.

A further alternative fastening method of the light rod according to the invention is as follow. When the light rod is fastened directly during manufacturing of an object, manufactured by preferably a plastic compatible to the light rod and it can consist of a boat, car body, container or an airplane body, a swimming pool or the like and which is manufactured in a mould. In this case the light rod or light rods are placed out in the mould in which the object is cast in and in a number desired and of a form of the light rod desired, whereupon the light rod is cast into or are laminated into the material of the object directly during the manufacturing of the object.

1. A lens or light rod for creating of a transparent coloured or uncoloured light transmission, in the first hand preferably in an object in the form of a body of a plastic boat, car body, aircraft body or the like or objects in the form of tanks, swimming pools or the like, whereby a light communication can be maintained through the same or from an embedded light source and outwards, characterized in that the light rod (1) comprises a body (2) of a plastic material chemically or mechanically compatible to the actual fastening position, said body has an extension, which after fastening makes a fixing in position of the body (2) possible to the inside (4) of the object (3) and also an accommodation of that portion of the body, which protrudes in a direction outside the object (3) by working of the same into the outer contour (5) of the object (3), alternatively vice versa during mounting of the light rod in an object in the form of tanks, swimming pools or the like where the protruding portion of the light rod by working is accommodated to the inner edges and inner form of the object.

2. A light rod according to claim 1, characterized in that the body (2) is designed by a transparent plastic having eventual embedded reinforcements, an eventual reflection layer (6) and an eventual enclosing, reinforced outer layer (7), said later layers are manufactured before or after the mounting of the body (2), where in its outer layer eventual fastening devices are integratable.

3. A light rod according to claim 1, characterized in that the body (2) forming the light rod (1) is tube formed in cross section, square formed, oval-shaped or formed edged and that said body has a longitudinal section, which is formed straight, conically or spherically.

4. A method to manufacture a lens or light rod according to claim 1, characterized in that the light rod (1) is prefabricated in all stages from only the transparent portion, the transparent portion is provided with a colour and/or embedded reinforcements, the transparent portion is provided with or without a reflection layer (6), and an enclosing layer (7), provided with or without a flange for mechanically mounting via a bolt- or screw joint and/or other fastening devices, intended for fastening of the light rod (1) to a base or for fixing equipment details of the light rod (1), that the transparent part or body (2) of the light rod (1) is casted or mounted mechanically in its enclosing casting and that the light rod during use of embedded transmitters is covered in its one end of the enclosing layer.

5. A method according to claim 4, characterized in that all layers of the light rod (1) are manufactured by plastic materials having the same chemical mixture or other compatible materials with those plastic materials used during the manufacturing of the actual object.

6. A method according to claim 4, characterized in that the light rod (1) is provided with a flange, where the material in said flange is manufactured of a plastic of the same mixture as the light rod.

7. A method for fastening of a lens or light rod according to claim 1 in preferably an object in the form of a plastic boat body, car body, aircraft body or the like or objects in the form of tanks, swimming pools or the like, characterized in that an opening is made in the object (3), the light rod (1) is inserted into the opening such a distance that a part or portion of the same protrudes outside the outer contour/inner contour of the object (3), a compatible plastic material to the light rod (1) and the object (3) is applicated between the inside/outside of the object and that portion of the light rod, which is inside outside and protrudes inwards/outwards in said object (3) for fixing and integrating the light rod (1) into said opening and object, whereupon that portion of the light rod being outside/inside the object is accommodated to the form of the outer contour/inner contour of the object (3) by working.

8. A method for fastening of a light rod according to claim 1 in preferably an object in the form of a boat body, car body, container, tank or the like, manufactured by wood, metal, concrete or other material which is not reinforced plastic, characterized in that an opening is made in the object (3), whereupon the light rod (1) is inserted into the opening so that it extends outwards alternatively lies in a level with the opposite side of the object (3), and a collar or flange which is prefabricated and provided on the side of the light rod or manufactured during the mounting of the same, said collar or flange is integrated into the enclosing layer of the light rod (1), by aid of bolts or screw joints fixing the light rod (1) to the object (3), whereupon the light rod (1) is accommodated to the opposite side contours of the object (3) by working.

9. A method for attachment of a lens or light rod according to claim 1 directly during the manufacturing of an object, manufactured by preferably to the light road compatible plastic material, and which can be a boat, a car body, a container, an aircraft body, a swimming pool or the like and which is manufactured in a mould, characterized in that the light rod or the light rods (1) are placed into that mould said object (3) is cast into, and in a number desired and having a light rod formation desired, whereupon these light rods are embedded into or laminated into the material of the object (3) directly during the manufacturing of the object (3).
